(19) United States
(12) Patent Application Publication
(10) Pub. No.: US 2012/0043224 A1
(43) Pub. Date: Feb. 23, 2012

(54) METHOD AND DEVICE FOR SCRUBBING EFFLUENTS

(75) Inventors: Michel Lopez, Coursan (FR); Patrice Capeau, Aix-en Provence (FR); Pascal Gendrot, Jouy en Josas (FR)

(73) Assignee: OREGE, Jouy en Josas (FR)

(21) Appl. No.: 13/201,583

(22) PCT Filed: Feb. 16, 2010
(86) PCT No.: PCT/FR2010/000131

§ 371 Date: Sep. 16, 2011

(30) Foreign Application Priority Data
Feb. 16, 2009 (FR) 0900705

(51) Int. Cl. C02F 1/465; C02F 1/70; C02F 1/463; C02F 1/72; C02F 101/30; C02F 101/10

(52) U.S. Cl. 205/744; 204/273

(57) ABSTRACT

The invention relates to a method and to a device for scrubbing liquid effluents laden with dissolved or undissolved organic and/or inorganic substances and continuously fed at a flow rate Df. After a preliminary effluent-floating operation if required, the method comprises carrying out at least one treatment cycle, the treatment cycle including a first step in which the effluents are subjected to an electrolytic treatment by circulation in a first compartment while generating a very strong turbulence, followed by a second step in which the undissolved elements contained in the effluents are agglomerated by coagulation/flocculation before circulating the effluents in a second free surface compartment, with the scraping of the sludge carried out at the upper portion, while bubbling and maintaining a reduced turbulence in said second compartment.

The present invention relates to a method for scrubbing liquid effluents laden with dissolved or undissolved organic and/or inorganic substances.

The invention makes it possible to bring the effluents to below a given COD and/or a given COD/BOD5, but also to lower the TOC (total carbon) content and the SM (suspended matter) content to values below a given threshold.

The invention also relates to an installation for scrubbing such effluents.

One particularly important, although not exclusive, field of application of the invention is in the scrubbing of petroleum effluents or effluents resulting from processes for the manufacture of agricultural products, particularly effluents having a very high initial COD [>30,000 mg O₂/l, or mg/l by the writing convention as used hereinafter], the carbon chains of which are long, that is to say difficult to degrade. The invention also makes it possible for example to carry out a treatment of diffuse pollution comprising complex molecules such as those of complex pesticides.

The COD or Chemical Oxygen Demand is the consumption of oxygen by strong chemical oxidizing agents that is necessary for oxidizing organic (and inorganic) substances in water. The COD enables the polluting load of wastewater to be evaluated and measures the totality of oxidizable substances, which includes those that are biodegradable.

The amount of matter biodegradable by biochemical oxidation (oxidation by aerobic bacteria that draw their energy from redox reactions) contained in the water to be analyzed is, itself, defined by the parameter BOD (Biological Oxygen Demand).

It is known that liquid effluents, often termed waste-water and this constituting the main example of such effluents, by nature contaminate the environments into which they are discharged.

Now, effluents with too high a COD and/or too low a BOD are harmful.

This is because the non-biodegradable matter that such effluents contain is made to be slowly oxidized by the dioxygen dissolved in the water or by that of the air on the surface of the effluents.

Since dissolved gaseous oxygen is essential for life, too high a demand in a riverwater or on the surface of a sheet of water will be injurious to animal and plant life, hence the need for treatment.

Many methods for the treatment of wastewater and/or other effluents resulting from chemical processes, for the purpose of discharging them into the environment, are already known.

These treatments may be carried out collectively, in a water purification plant, or individually.

Thus, there are water purification plants for obtaining acceptable COD and/or BOD levels especially by an oxidizing treatment, permitting discharge into the environment.

However, such plants have drawbacks.

Specifically, they require large sites that in general have to be located away from inhabited areas, on account of irksome, or even toxic, odors or aerosols being emitted. They also have high operating costs and limited effectiveness, being less and less acceptable because of the increase in regulatory requirements in respect of discharging.

In particular, COD levels below 1 000 mg/l, or indeed well below this value, are presently required, something which proves to be impossible to obtain in the case of certain effluents, for example those from oil production plants or in the case of petroleum-derived effluents in a saline medium.

Moreover, in the case of particular effluents that have newly appeared, the conventional methods prove to be ineffective.

It is therefore often the case at the present time not to be able to achieve the required levels for discharging into the environment, thereby incurring exorbitantly costly solutions such as, for example, incineration.

It will be understood, in particular when such effluents are generated in a remote hostile environment, as is the case on an offshore drilling platform, that substantial transport costs also have to be borne.

Although an effective solution (FR 2 914 919) has recently been proposed to meet this long-unfulfilled requirement, this may still be improved.

The aim of the present invention is to provide such a method, and a corresponding effluent treatment installation, better meeting the requirements in practice than those previously known, especially in that the invention allows compact, economic and effective treatment based on a combination of individual or multiple successive treatments, comprising one or more clearly differentiated steps, namely:
on the one hand, mechanical/chemical application step, the chemical step possibly being either oxidizing or reducing or oxidizing/reducing, depending on the type of effluent to be treated, knowing that in the embodiments more particularly described this involves a radical oxidation, also called hyperoxidation; and
on the other hand, a flotation step with skimming-off.

For this purpose, the invention essentially provides a method for scrubbing liquid effluents laden with dissolved or undissolved organic and/or inorganic substances and continuously fed at a flow rate D_{f}, characterized in that, after a prior effluent flotation operation, if this is required, at least one treatment cycle is carried out, said treatment cycle comprising a first step, in which a radical oxidation and/or a radical reduction of the effluents is carried out by circulation in a first compartment generating very strong turbulence, and then a second step, in which the undissolved substances contained in the effluents are agglomerated by coagulation flocculation before circulation of these effluents in a second compartment having a free surface, with scraping of the sludge obtained in the upper portion, while bubbling and maintaining a weak turbulence in said compartment.

Advantageously, the oxidation and/or reduction takes place by electrolytic treatment.

The term “electrolytic treatment” is understood here to mean an oxidation and/or a reduction by an electrolysis process with a very high electrochemical reactivity, enabling radical chemical species to be produced.

Such a method makes it possible to obtain a COD below given threshold values and, if required, to lower the COD/BOD5 ratio and/or the SM content to below a second and a third given threshold respectively.

The method also makes it possible to seek a BOD/COD ratio above a particular value, this being advantageous for subsequently facilitating biological decontamination.

The term “very strong turbulence” should be understood to mean agitation by a recirculating pump in the compartment in question, such that the output of the pump is more than five times higher than the continuous feed flow rate D_{f} and advantageously more than ten times higher or even up to fifty times higher, or indeed higher still, than said flow rate D_{f}.

In other words, the vertical hydraulic flow regime in the chamber is a highly turbulent flow regime (Re>>3000 m²/s) resulting, in combination with the hyper-oxidation, in cracking and scission of the long polluting molecules.

The term “weak turbulence” should be understood to mean that the hydraulic flow regime in the compartment is maintained close to the laminar flow regime (Re<2000 m²/s), for example by slight agitation obtained by the recirculation of the effluents at a flow rate close to or lower than that of the continuous feed, i.e. at a flow rate q≦D_{f}.

Thus, and in particular, such a method utilizes organized vertical flows to the detriment of horizontal flows, which are practically banished, so that the encounters between the interacting elements are maximized. The water to be purified is itself used here as reactant by virtue of the pumping and the recirculation of the purified product itself, said product carrying an oxidizing function.

In advantageous embodiments, one and/or other of the following arrangements may additionally be employed:
the electrolytic treatment is an oxidation;
strong turbulence is generated in the first compartment by agitation, making the effluents flow between the top and the bottom of said compartment at a flow rate Q≧5D_{f};
the recirculation flow rate is such that Q≧25D_{f}, advantageously Q≧40D_{f} or ≧50D_{f};
the electrolytic treatment is carried out by circulation of the effluents captured in the bottom portion of the first compartment and reintroduction into the top portion of said compartment through an electrolysis circuit;
the electrolytic treatment is carried out by electrolysis on electrodes coated with a layer comprising diamond and boron;
the electrolytic treatment is carried out by electrolysis on electrodes coated with a layer comprising carbon and nitrogen atoms;
weak turbulence is maintained in the second compartment by making the effluents flow in the bottom portion of said compartment at a flow rate q≦D_{f} using external cavitation means for generating vertical bubbling;
the effluents are degassed on leaving the electrolysis circuit and the gases obtained are used to feed the external cavitation means for the vertical bubbling;
the method comprises at least two treatment cycles;
the method comprises at least one highly oxidizing treatment cycle and at least one highly reducing treatment cycle. The term “highly oxidizing” (or conversely “highly reducing”) is understood to mean essentially an oxidizing agent, that is to say an agent which makes the chemicals present in the effluents lose (or conversely gain) electrons;
the effluents are made to flow in series through n treatment cycles, the number n≧2 being such as to obtain, little by little, a solid/liquid phase separation on the surface of the compartments having a free surface so as to bring the effluents leaving the treatment to a defined, a defined COD;
each treatment cycle additionally includes an intermediate step between the first and second steps, in which intermediate step a post-oxidation and/or post-reduction operation is carried out with a catalyst.

Advantageously, this operation is carried out in an intermediate third compartment, allowing the flow and the bubbles produced by electrolysis to rise to the top. Again advantageously, moderate turbulence is also generated in said third compartment;
the effluents are injected into the third compartment in the bottom portion of said compartment from a tap-off of the electrolysis circuit at the flow rate D_{f}, for example by making the effluents in the bottom portion of said compartment flow at a moderate flow rate (D_{f}<d<3D_{f}). In other words, the post-oxidation and/or post reduction operation is carried out by withdrawing the effluents at the outlet of the electrolysis circuit at the flow rate D_{f};
the prior bubbling flotation operation is carried out after coagulation flocculation and then recirculation of the effluents in the bottom portion of a chamber having a free surface, with weak turbulence, said chamber being provided with scraping means in the top portion and with cavitation means for generating vertical bubbling for oxidation/separation in said chamber;
the radical oxidizing agent is, by itself or in combination, chosen from the oxidizing agents H₂O₂, O₃ O° and OH°; and
the method additionally includes a biological filtration.

By virtue of the scission or cutting of the length of the molecules which are obtained with the above steps of the method, the COD/BOD5 ratio becomes very favorable and such an additional biological treatment enables an even more exceptional result to be achieved.

The invention also provides an installation for implementing one or more of the embodiments of the method described above.

The invention also provides an installation for scrubbing liquid effluents laden with dissolved or undissolved organic and/or inorganic substances, and continuously fed at a flow rate D_{f}, characterized in that it comprises at least one first set of two successive vertical compartments, namely a first compartment provided with means for the radical oxidation and/or radical reduction of the effluents and comprising means for generating very strong turbulence in said first compartment, and a second compartment, having a free oxidation/separation surface designed to maintain weak turbulence in said second compartment, said second compartment being provided with external coagulation flocculation means, with scraping means in the top portion, and with bubbling means, the compartments communicating with each other in the bottom portion.

In fact, the coagulation flocculation steps are performed outside the second compartment by said external means. The effluents that have benefited from these two actions are then injected into the second compartment, and will then be able to be dissociated into water on the one hand and into supernatant pollutant on the other, through the action of the bubbling in said effluents.

In advantageous embodiments, one and/or other of the following arrangements may additionally be employed:
the device includes electrolytic treatment means for carrying out the oxidation and/or the reduction.

The expression “electrolytic treatment means” is understood to mean treatment means for oxidation and/or reduction by electrolysis (comprising electrodes);
the means for generating very strong turbulence comprise a first circuit for the recirculation of the effluents captured in the bottom portion of the compartment and reintroduced into the top portion at a flow rate Q≧5D_{f};

the flow rate Q is ≧25D_{f}, advantageously Q is ≧40D_{f} or 50D_{f};
the installation includes a preflotation chamber with a free surface and weak turbulence, comprising external coagulation/flocculation means and effluent recirculation means in the bottom portion, said chamber being provided with scraping means in the top portion and with cavitation means for generating vertical bubbling for oxidation/separation in said chamber;
the electrolytic treatment means comprise electrodes coated with a layer comprising diamond and boron;
the electrolytic treatment means comprise electrodes coated with a layer comprising carbon and nitrogen atoms;
the electrolytic treatment means are located in the first effluent recirculation circuit;
the second compartment comprises a second effluent recirculation circuit in the bottom portion, which includes cavitation means for generating vertical bubbling in said compartment;
the flow rate in the second recirculation circuit is low, being between D_{f}/20 (one twentieth of D_{f}) and D_{f}/2 (one half of D_{f});
the installation comprises at least one second set of compartments in series with the first;
the installation comprises n sets of compartments in which the effluents are made to flow in series, the number n≧2 being such as to obtain, little by little, a solid/liquid phase separation on the surface of the compartments having a free surface so as to bring the effluents leaving the treatment to a defined COD;
each set of compartments includes at least one intermediate third compartment between the first and second compartments, in which a post-oxidation and/or post-reduction operation is carried out with a catalyst, the effluent being agitated with moderate turbulence;
the installation comprises, in the bottom portion of said third compartment, a third effluent circulation circuit with a flow rate D_{f}≦d≦3D_{f} in order to generate moderate turbulence in said third compartment;
the intermediate third compartment is fed in the bottom portion from the first circulation circuit which is itself provided with the electrolytic treatment means;
the cavitation bubbling is carried out with air, the mean size of the equivalent diameter of the bubbles being between 0.2 mm and 1 mm; and

the compartments have a useful height of between 3 m and 5 m.

The invention will be better understood on reading the following description of embodiments given by way of nonlimiting examples. The description refers to the accompanying drawings in which:

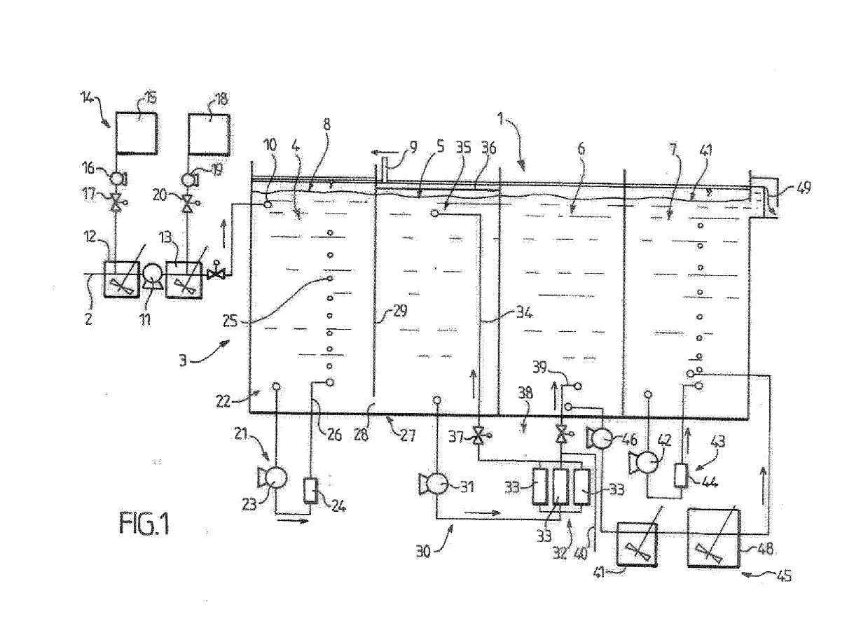

FIG. 1 is a diagram showing the operation of a first embodiment of an installation according to the invention;

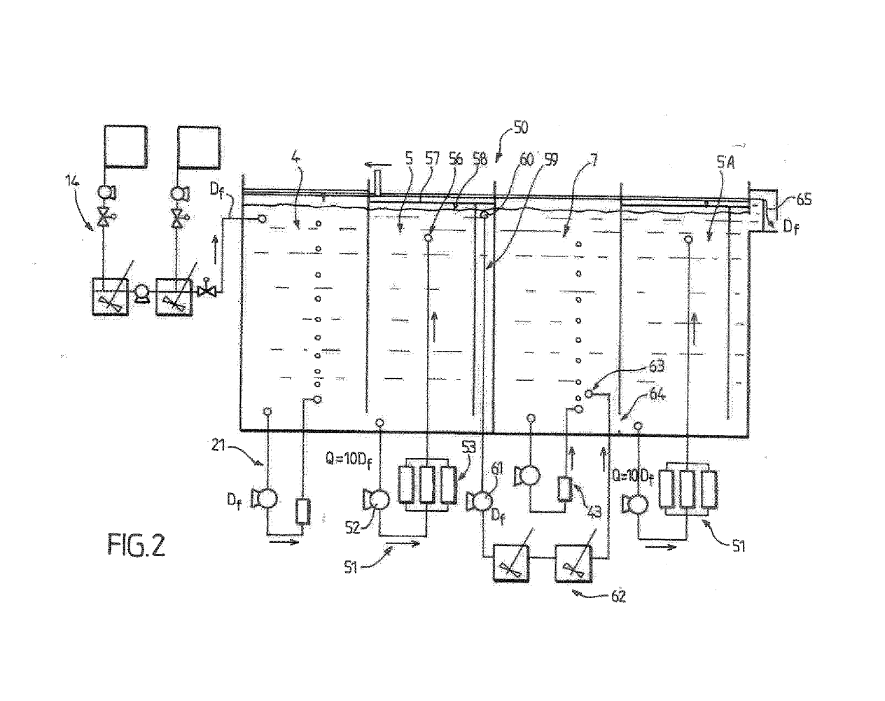

FIG. 2 is a diagram showing the operation of a second embodiment of an installation according to the invention;

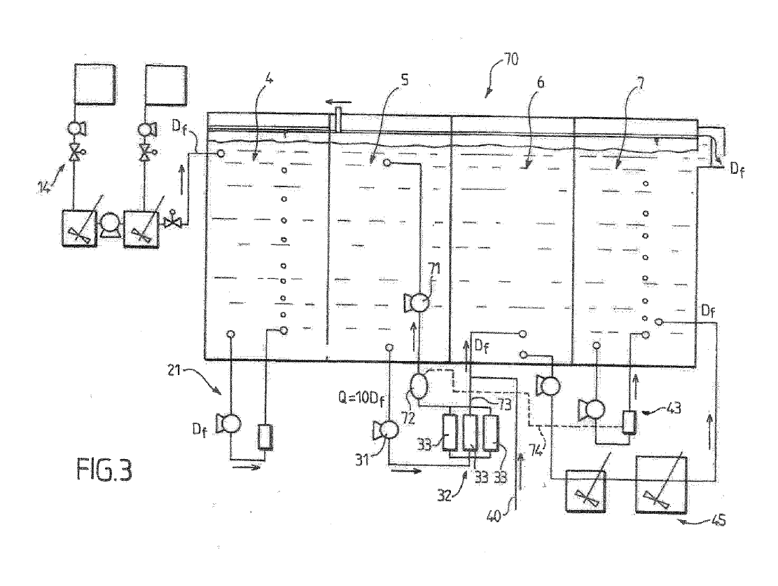

FIG. 3 is a diagram showing the operation of a third embodiment of an installation according to the invention;

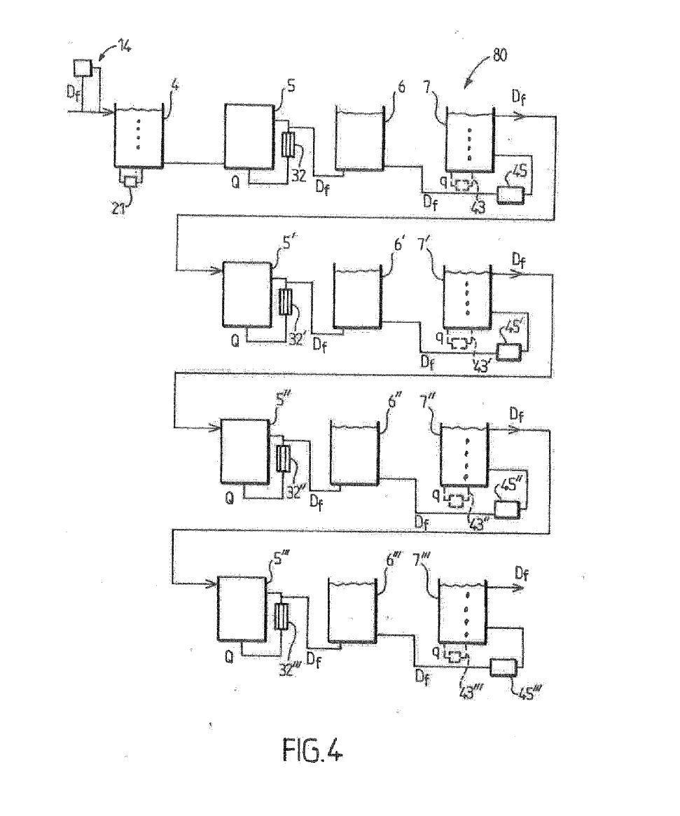

FIG. 4 is a schematic view illustrating a succession of treatment cycles according to FIG. 3;

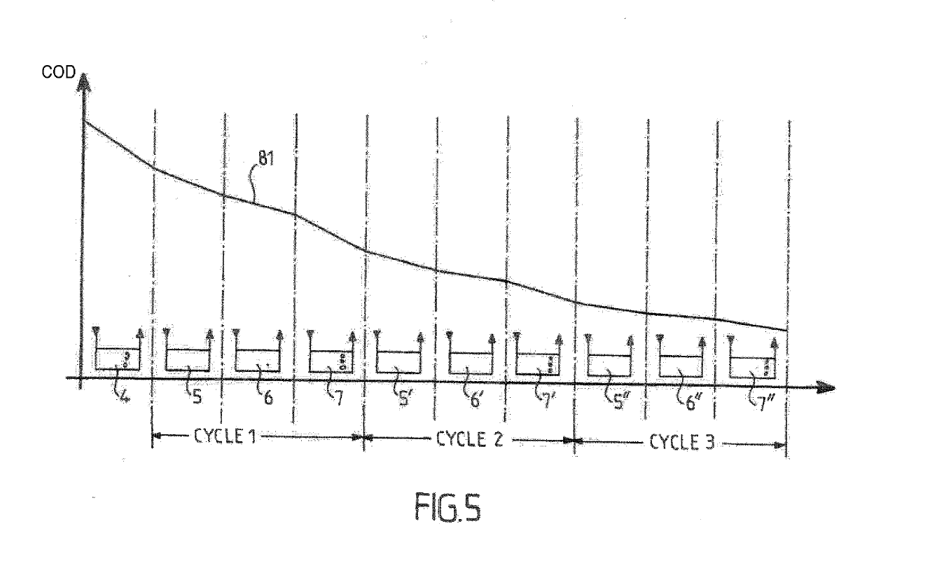

FIG. 5 is a graph showing the decrease in COD in a succession of cycles of the type corresponding to FIG. 4; and

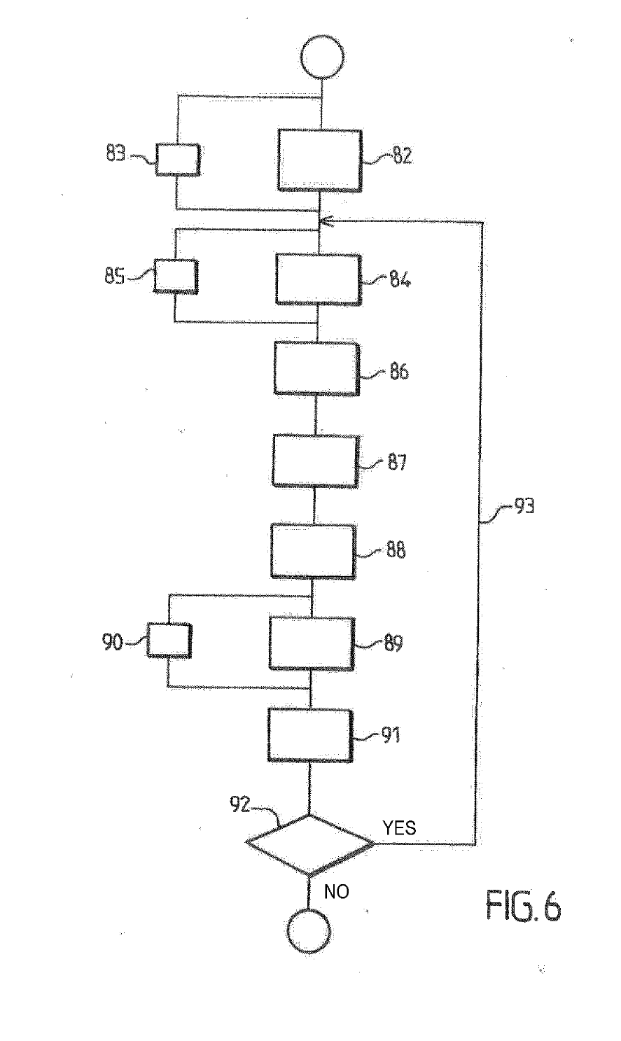

FIG. 6 is a flow chart showing the steps employed in one embodiment of a method according to the invention.

FIG. 1 shows an installation 1 for scrubbing effluents continuously injected at 2 with a flow rate D_{f}, for example 1 m³/h.

The effluents are laden with dissolved or undissolved organic and/or inorganic substances, for example with a COD of 30 000 mg of oxygen O₂/l.

The installation 1 is for example formed by a parallelepipedal steel tank assembly 3 with a height of 3 m, for a total volume of around 2 m³, which comprises four successive parallelepipedal vertical compartments 4, 5, 6 and 7 having dimensions calculated according to the recirculation and residence time conditions within the competence of a person skilled in the art.

More precisely, and in the example more particularly described here, the installation comprises a preliminary compartment or float chamber 4 with a volume of around 0.3 m³, a first, radical oxidation compartment 5 of larger volume, for example 1 m³, a second, oxidation/separation compartment 7 of lower volume, i.e. 0.3 m³, and, between the first and second compartments, an intermediate third compartment 6 of substantially the same volume, i.e. 0.3 m³, in which a post-oxidation operation is carried out.

The float chamber 4 has a free surface 8 and includes scraping means 9 for removing the solid floating materials, for example giving them to a recovery tank (not shown).

Other embodiments of the installation are of course possible, for example an installation formed by a cylindrical open tank assembly, the compartments and the prior chamber of which form radially disposed quarters, a sludge recovery compartment then being provided in said cylinder, after the second compartment, and the scraping means being circular and continuously rotating.

The float chamber 4 is fed at 10 via an inlet pump 11 into the top portion of the chamber.

The effluents are pretreated in line via mixer tanks 12 and 13, coagulating and flocculating them.

To do this, reactant feed means 14 are provided. These comprise for example a first feed tank 15, for continuously feeding, by a metering pump 16 and a solenoid valve 17, a coagulation reactant known per se and a second feed tank 18, for continuously feeding, by a metering pump 19 and a solenoid valve 20, a flocculation reactant, again of known type, said reactants each being adapted according to the effluent to be treated, within the competence of a person skilled in the art.

The float chamber additionally includes effluent recirculation means 21 in the bottom portion 22, with a low flow rate, for example substantially equal to the flow rate D_{f}.

These recirculation means 21 comprise a pump 23, for example with an output of 0.1 m³/h, and cavitation means 24 for generating vertical bubbling 25 in the float compartment via a right-angled pipe 26, for optimum oxidation, said pipe therefore opening into the bottom portion of the chamber 4.

The first compartment 5, for radical oxidation, also hereinafter called hyperoxidation, is connected to the prefloat chamber 4 in the bottom portion 27 via a passage, for example having a diameter corresponding to the flow rate D_{f}, which is either formed by an orifice 28 made in the wall 29 separating the first compartment from the float chamber, or, if the float chamber is a certain distance away from this compartment, formed by a pipe permitting a flow rate D_{f}.

The first compartment 5 comprises external radical oxidation means 30 comprising a circulating pump 31, for example with a large output of 30 m³/h and electrolytic oxidation means 32 comprising several electrodes 33, for example diamond-coated electrodes 33, for example three sets of five consumable electrodes, placed in parallel and in line with a feed pipe 34 which opens into the top part 35 of the first compartment 5.

In the embodiment described in FIG. 1, this first compartment also has a free surface 8, but is closed in the top portion by a cover 36.

The electrolytic radical oxidation means 30 are designed to recirculate the effluent in the first compartment with a flow rate of around 29 m³/h. (An average residence time of one hour in the 1 m³ compartment is then observed, said compartment being moreover fed via the orifice 28 with this flow rate of 1 m³/h).

The circuit 30 also allows effluent with a flow rate of D_{f} to be tapped off and sent to the intermediate third compartment 6 for post-oxidation treatment.

Regulating valves 37 placed in parallel in the circuit downstream of the electrodes 33 allow the flows between the first compartment 5 and the intermediate third compartment 6 to be regulated.

The effluent is injected into the bottom portion of the compartment at the flow rate D_{f}, here again, for example by a right-angled pipe 39.

A catalyst, for example ferrous ions Fe₂+ or cuprous ions Cu⁺, or more generally metals close to losing an electron, such as sodium, is also introduced at 40 into this injection line, therefore enabling as effective a post-oxidation treatment as possible.

The catalysts serve to supplement the chemistry work of the electrochemically generated free radicals, disproportioning the hydrogen peroxides or organic peroxides produced for example by incorporation into the downstream stream of Fe, Fe₂O₃ or Fe₃O₄ in granular solid form implemented by means of a filter or a fluidized bed or by the injection of a solution of reduced ions, such as Fe²+.

The expression “into the downstream stream” means directly downstream of the electrodes and on an ancillary recirculation stream placed in the same region (dedicated to the chemistry) of the same compartment.

It should also be noted that microporous or nanoporous supports, such as active carbons, resins or zeolites, may be incorporated either in each bottom portion region or on the last bottom portion region. The function of these supports is therefore to fix, concentrate the diffuse pollution on absorbent sites so that the water leaves definitively purified therefrom.

Finally, the installation 1 comprises a second compartment 7 with an oxidation/separation free surface 41, designed to maintain weak turbulence in said compartment by means of a small recirculating pump 42 connected to bubbling oxidation means 43 via a cavitation device 44 known per se.

It should be noted that the scraping means 9 of the preliminary chamber may for example also be used to scrape the free surfaces of all the compartments and in particular, and more specifically, the second and third compartments 7 and 6, which allow the products solidified on the surface to be separated by flotation.

The intermediate third compartment and the second compartment are joined together in the bottom portion via coagulation/flocculation means 45 comprising a pump 46 with an output of D_{f} and two reactant mixer units 47 and 48 known per se and located in line in the circuit.

Finally, the effluent is removed in the top portion 49 with the flow rate D_{f}, for example via an overflow, for optional subsequent treatment.

FIG. 2 shows another embodiment of an installation 50 according to the invention.

In the rest of the description, the same reference numbers will be used to denote identical or similar elements.

The installation 50 comprises a preliminary float chamber 4 provided with coagulation/flocculation means such as those described with reference to FIG. 1, fed with the flow rate D_{f}, for example 5 m³/h.

It comprises a first hyperoxidation compartment provided with very high turbulence agitation means 51 comprising a high-output pump 52 and with electrolytic oxidation means 53, for example using diamond-coated electrodes as described above.

The effluents enter for example at 50 m³/h in the bottom portion 54 of the first compartment 5 and discharge them at the top portion 56.

The first compartment 5, which here is closed at 57, although it does have a free surface 58, by an optionally removable sealed cover, includes a lateral vertical chamber 59 of small parallelepipedal volume for intake of effluent in the top portion 60 by a pump 61 with an output D_{f} feeding coagulation flocculation means 62, known per se, before the effluent is discharged into the bottom portion 63 of a second compartment 7 of the type described with reference to FIG. 1.

This second compartment, which also includes cavitation bubbling means 43, is connected in the bottom portion to an additional compartment 5A identical to the first compartment 5 described above.

The very highly turbulent additional hyperoxidation treatment by virtue of the external circuit 51 enables the reduction in COD to be further improved, the effluents then being discharged at 65 with the flow rate D_{f}.

FIG. 3 shows another embodiment of an installation 70 according to the invention.

This installation 70 comprises a preliminary chamber 4 provided with flocculation/coagulation means as described above.

It also comprises a first compartment 5 identical to the compartment described with reference to FIG. 1, with a free surface, additionally including a submerged pump 71 for increasing the flow rate, and a degassing pot 72 downstream of the take-off 73 of the effluent circuit after the electrolytic oxidation circuit 32, which degassing moreover is for example used (broken line 74) for the bubbling/cavitation (44) at the second compartment 7 as described with reference to FIG. 1.

As regards the intermediate compartment 6, this is advantageously fed at 40 with catalyst of the Fe²⁺ type, as described above.

FIG. 4 shows an installation 80 according to a particularly advantageous embodiment of the invention which in this case comprises more than two cycles, namely four treatment cycles identical to the type of those described with reference to FIG. 3.

After a float chamber 4 fed with effluents with the flow rate D_{f} after coagulation/flocculation 14, effluent is fed into the bottom portion of a very highly turbulent hyperoxidized compartment 5.

After a treatment time of around one hour in the compartment 5, a flow is tapped off after the electrolytic oxidation circuit 32 equal to the flow rate D_{f} so as to feed the bottom portion of the intermediate third compartment 6, which itself feeds, via the flocculation/coagulation circuit 45, in the bottom portion, the second compartment 7 having a free surface, provided with scraping means, and with bubbling 43 generating weak turbulence.

The effluents are then discharged, for example via an overflow, into an identical second cycle 5′, 6′, 7′, which itself feeds similarly a third cycle 5″, 6″, 7″ in turn connected in series with a fourth cycle 5′″, 6′″, 7′″ before being discharged for additional treatment, for example for biological treatment (not shown).

FIG. 5 shows the variation in graphical form (curve 81) of the COD content of pretreated effluents as a function of the addition of successive cycles of the type of those described with reference to FIG. 4, in which it may therefore be seen that said curve 81 steadily decreases.

It may thus be seen that by increasing the number of cycles it is possible to lower the COD to a never equaled level, by virtue of the method of the present invention.

According to one of the features of the method, the effluent is, as we have seen, itself used to carry out the desired physical and chemical work.

It is thus the kinetic energy generated in a volume of the effluent that allows the production of bubbles, but it is also this energy that breaks the emulsions of the product itself.

Finally, it is the capability of the product itself to conduct electricity which makes it possible to introduce oxidizing reactants produced on the water molecules contained in the effluent, as is the case in an electrolytic oxidation.

A large saving in material and in energy is thus achieved, this being one of the great advantages of the present invention.

One embodiment of the method according to the invention and a means of implementing said method will now be described with reference to FIG. 6.

After a first step 82 of separating the suspended matter and colloids with recirculation at 83 with a low flow rate inside the preliminary chamber, a radical oxidation or hyperoxidation is carried out at 84 with circulation with a very high flow rate with recirculation 85 on diamond-coated electrodes.

The preliminary step 82 will have enabled, by means of the physicochemical treatment with flotation and micro-bubbling, the COD to be significantly reduced on the most easily accessible elements by a conventional process.

The radical oxidation step 84 then follows, as just mentioned, which step will then be repeated possibly several times depending on the number of cycles.

This hyperoxidation phase proves to be that which truly enables, above all if it is repeated, complex molecules to be destroyed.

Said phase makes it possible to break the heel of the COD and to lower the COD to below 120 mg/l. It also increases the COD/BOD5 ratio (BOD 5 is the 5-day biological oxygen demand) and thus shows great biodegradability of the substrate by cutting the molecular chains, making it possible in the end to obtain the smallest possible organic structure, i.e. CO₂.

It is thus possible with the invention to lower the COD/BOD5 ratio to below 2 and advantageously substantially below 1.5, for example to 1.2.

In the embodiment more particularly described, the hyperoxidation is carried out using OH₀ ions obtained by electrolysis.

These ions are produced here on the surface of flat electrodes stacked in parallel and inserted in a module with a thickness of a few tens of millimeters.

Mass transfer is caused upon contact with the electrodes, and the presence of the most turbulent flow possible through the thickness results in the entrainment of microbubbles.

Because of this electrolysis, for example carried out with a flow rate that may be around 10, 15 or even 50 m³/h in order to make the fluid effective and to load it sufficiently with oxidizing agent OH₀; the latter therefore becomes hyperoxidizing.

It may therefore be seen that the chemical interactions become fleeting and violent, the hydroxide radical tearing a proton H+ and an electron from the first organic structure that it encounters, so as to reform a stable water molecule.

It will therefore be understood that this phenomenon is accompanied by a cleavage of the carbon structure producing a radical structure seeking a hydrogen to be removed.

Thus, the organic material undergoes an oxidation reaction chain, which may be exploited.

The electrolysis also produces a very large concentration of microbubbles which appear to function as surface-active structures for the organic molecule.

Upon passage of a microbubble, it is therefore found that the molecule is attached thereto via its hydro-phobic pole and rises toward the surface.

The denser the bubbling, the better the extraction and the more effective the skimming off process.

For example, an effluent on which the method according to the invention can be applied is described below based on what is called “white” water.

This is an effluent of milky appearance, with a pH close to neutrality (pH=6.8), produced by centrifugation followed by flotation, having allowed de-oiling. The effluent then is at a temperature of around 60° C.

More precisely, the treated products are organic materials resulting from the treatment of oleaginous seeds after subtraction of lipid materials.

These residues stem from the refining of seeds followed by a centrifugation phase used to subtract the oily complement.

The effluent to be treated thus consists of the following:
proteins, 2 to 3% of the dry matter:
oily residues not recovered by centrifugation, including waxes (fatty acids containing 30 carbon atoms), 20 to 30% of the dry matter; and
glucides (predominantly starches): the remainder of the dry matter.

In other words, the effluent consists predominantly of long-chain carbon structures or assemblies of these molecular structures.

It is in the form of an emulsion with a reference COD lying between 15 000 and 30 000 mg/l.

Such an effluent after treatment with a cycle consisting of two or even three flotation/hyperoxidation operations as described above, with an initial flow rate of 5 m³/h for a total chamber volume of around 26 m³, makes it possible to lower the COD to well below 500 mg/l or even 100 mg/l.

With reference to FIG. 6, the following step is an intermediate step 86 of natural flotation with bubbles by means of a cavitation circuit, with coagulation at 87, flocculation at 88 and then removal at 89 in a compartment with a free surface, of the second compartment 7 type described above, recirculating the effluent with a low flow rate at 90, with bubbling by cavitation, so as to allow defective flotation.

The effluent is also withdrawn with a flow rate D_{f} continuously at the top portion at 91, with scraping of the solid foam obtained.

In the embodiments, there also may or may not be the possibility at 92 of repeating the preceding steps 84 to 91 n times (line 93).

Given below is an example of the use of the installation according to the embodiment described more particularly with reference to FIG. 2.

This installation was used for successfully treating the water of a chemicals storage site containing traces of the products listed below, for a total COD of 500 to 2 000 mg/l.

The electrolytic treatment here served for oxidizing and/or reducing, depending on the molecule in question, the following molecules that were present: ethyl acetate, acetone, heptanoic acid, sulfuric acid, benzene and bitumen, butyl diglycol ether, methylene chloride, 1,2-dichloroethane, gasoline, ethanol, ethyl-hexanol, oils and additives, isobutanol, potassium hydroxide lye, methanol, methyl ethyl ketone, mono-ethylene glycol, normal-butanol, rather ethanol, propylene glycol, carbon tetrachloride, tetrahydro-furan, toluene, 1,1,1-trichloroethane, trichloromethane, trichloroethylene, heavy fuel, xylene.

The particularly convincing results obtained despite the complexity of the effluent treated have enabled the following tables 1 and 2 to be drawn up:
Table 1 gives the results obtained in tests carried out with a 3 m³ reactor, the simplified results of these tests being indicated in columns 1 to 11;
Table 2 shows more particularly, and by way of example, the results obtained with certain polluting molecules before and after treatment upon one of the tests (test 2) of table 1.

TABLE 1

| | Test No. | | | | | | | | | | |
|---|---|---|---|---|---|---|---|---|---|---|---|
| | 1 | 2 | 3 | 4 | 5 | 6 | 7 | 8 | 9 | 10 | 11 |
| COD (mg/l) | 500 | 500 | 500 | 1890 | 1400 | 1400 | 1800 | 1800 | 1900 | 1850 | 1850 |
| Output COD | 15 | 12 | 15 | 110 | 106 | 110 | 38 | 111 | 75 | 39 | 106 |
| (mg/l) | | | | | | | | | | | |
| Yield | 97% | 98% | 97% | 94% | 92% | 92% | 98% | 94% | 96% | 98% | 94% |
| Input pH | 7.7 | 7.7 | 7.7 | 6 | 6 | 3.5 | 6 | 6 | 6 | 6 | 6 |
| Output pH | 7 | 6.9 | 6 | 7 | 7 | 7.1 | 7.9 | 6.5 | 7 | 7 | 7 |
| Residence | 4 | 4 | 4 | 4 | 4 | 4 | 5 | 4 | 5 | 5 | 4 |
| time (h) | | | | | | | | | | | |
| Flow rate | 0.75 | 0.75 | 0.75 | 0.75 | 0.75 | 0.75 | 0.6 | 0.75 | 0.6 | 0.6 | 0.75 |
| (m³/h) | | | | | | | | | | | |

TABLE 2

| CHEMICAL ELEMENT | RESULTS BEFORE | | RESULTS AFTER | |
|---|---|---|---|---|
| Benzene | 58 | μg/l | 0.68 | μg/l |
| Toluene | 340 | μg/l | 4.3 | μg/l |
| Ethylbenzene | 300 | μg/l | 1.7 | μg/l |
| o-Xylene | 190 | μg/l | 2.5 | μg/l |
| M + p-xylene | 1200 | μg/l | 2.8 | μg/l |
| Dichloroethylene | 2.2 | μg/l | 1.6 | μg/l |
| Dichloromethane | 0.66 | μg/l | 16.06 | μg/l |
| Dichloroethane | 14 | μg/l | 0.73 | μg/l |
| Chloroform | 5900 | μg/l | 1500 | μg/l |
| Carbon | 420 | μg/l | <0.5 | μg/l |
| tetrachloride | | | | |
| Trichloroethane | 83 | μg/l | <0.5 | μg/l |
| Dichloroethane | 14 000 | μg/l | 2000 | μg/l |
| Trichloroethylene | 3 200 | μg/l | 9.7 | μg/l |

It will be noted here that certain pollutants coming in particular from the manufacturing industry are difficult to oxidize.

These are products designed to last and consequently to resist natural biological and/or chemical oxidation.

These products contain for example C—Cl—C—F or C—Br bonds.

In this embodiment of the invention, reduction and oxidation reactions are also set up.

In particular, this result is obtained all the more easily since the electrolytic cells used may comprise successions of anodes and cathodes, the reduction taking place at the cathodes (addition of electrons) and the oxidation at the anodes (loss of electrons).

Advantageously, it is also possible to saturate the effluent with oxygen.

Thanks to this saturation there then occurs at the cathode an alternation of oxidation and reduction of O₂, giving in particular an extremely reducing radical, namely the hyperoxide radical O₂^{-°}.

More precisely, the reactions implemented are in particular the following:
1. O₂+e⁻→O₂⁻° (hyperoxide radical)
2. O₂^{-°}+H⁺→HO₂° (perhydroxyl radical)
3. HO₂°+e⁻→HO₂⁻ (hydrogenoperoxide)
4. HO₂⁻+H⁺→H₂O₂ (hydrogen peroxide)
4. H₂O₂+e⁻→OH°+OH⁻ (hydroxyl radical)

It is thus possible to obtain a reduction on the oxygen bonds such as SO and NO present in nitrates and sulfates, which are particularly difficult to break.

It should be noted that step 4 produces the hydroxyl radical used in the hyperoxidation reaction.

As goes without saying, and as results moreover from the foregoing, the present invention is not limited to the embodiments more particularly described. Rather it encompasses all variants thereof and especially those in which the gas recovery means are designed to feed the venturis in the cavitation circuits of the second compartment, those in which the first and second compartments are placed one above the other in order to increase the compactness or those as described above in which the radical oxidation means are combined (or not) with radical reduction means.

1. A method for scrubbing liquid effluents laden with dissolved or undissolved organic and/or inorganic substances and continuously fed at a flow rate D_{f}, characterized in that, after a prior effluent flotation operation, if this is required, at least one treatment cycle is carried out, said treatment cycle comprising a first step, in which a radical oxidation and/or a radical reduction of the effluents is carried out by circulation in a first compartment generating very strong turbulence, and then a second step, in which the undissolved substances contained in the effluents are agglomerated by coagulation/flocculation before circulation of these effluents in a second compartment having a free surface, with scraping of the sludge obtained in the upper portion, while bubbling and maintaining a weak turbulence in said compartment.

2. The method as claimed in claim 1, characterized in that strong turbulence is generated in the first compartment by agitation, making the effluents flow between the top and the bottom of said compartment at a flow rate Q≧5D_{f}.

3. The method as claimed in claim 2, characterized in that Q≧25D_{f}.

4. The method as claimed in claim 1, characterized in that the oxidation and/or the reduction take place by electrolytic treatment.

5. The method as claimed in claim 4, characterized in that the electrolytic treatment is a radical oxidation.

6. The method as claimed in claim 4, characterized in that the electrolytic treatment is carried out by circulation of the effluents captured in the bottom portion of the first compartment and reintroduction into the top portion of said compartment through an electrolysis circuit.

7. The method as claimed in claim 6, characterized in that the electrolytic treatment is carried out by electrolysis on electrodes coated with a layer comprising diamond and boron.

8. The method as claimed in claim 6, characterized in that the electrolytic treatment is carried out by electrolysis on electrodes coated with a layer comprising carbon and nitrogen atoms.

9. The method as claimed in claim 1, characterized in that weak turbulence is maintained in the second compartment by making the effluents flow in the bottom portion of said compartment at a flow rate q≦D_{f} using external cavitation means for generating vertical bubbling.

10. The method as claimed in claim 9, characterized in that the effluents are degassed on leaving an electrolysis circuit and the gases obtained are used to feed the external cavitation means for the vertical bubbling.

11. The method as claimed in claim 1, characterized in that it comprises at least two treatment cycles.

12. The method as claimed in claim 1, characterized in that it comprises at least one highly reducing treatment cycle.

13. The method as claimed in claim 1, characterized in that the effluents are made to flow in series through n treatment cycles, the number n≧2 being devised so as to obtain, little by little, a solid/liquid phase separation on the surface of the compartments having a free surface so as to bring the effluents leaving the treatment to a defined polluting load, a defined COD and/or a defined TOC.

14. The method as claimed in claim 1, characterized in that each treatment cycle additionally includes an intermediate step between the first and second steps, in which intermediate step a post-oxidation and/or post-reduction operation is carried out with a catalyst, leaving the flow and the bubbles produced by electrolysis to rise to the top in an intermediate third compartment.

15. The method as claimed in claim 6, characterized in that the effluents are injected into the third compartment in the bottom portion of said compartment from a tap-off of the electrolysis circuit at the flow rate D_{f}.

16. The method as claimed in claim 14, characterized in that the post-oxidation operation is carried out by withdrawing the effluents at the outlet of the electrolysis circuit at the flow rate D_{f}.

17. The method as claimed in claim 1, characterized in that the prior bubbling flotation operation is carried out after coagulation/flocculation and then recirculation of the effluents in the bottom portion of a chamber having a free surface, with weak turbulence, said chamber being provided with scraping means in the top portion and with cavitation means for generating vertical bubbling for oxidation/separation in said chamber.

18. An installation for scrubbing liquid effluents laden with dissolved or undissolved organic and/or inorganic substances, and continuously fed at a flow rate D_{f}, characterized in that it comprises at least one first set of two successive vertical compartments, namely a first compartment provided with means for the radical oxidation and/or radical reduction of the effluents and comprising means for generating very strong turbulence in said first compartment, and a second compartment, having a free oxidation/separation surface designed to maintain weak turbulence in said second compartment, said second compartment being provided with external coagulation/flocculation means, with scraping means in the top portion, and with bubbling means, the compartments communicating with each other in the bottom portion.

19. The installation as claimed in claim 18, characterized in that the means for generating very strong turbulence comprise a first circuit for the recirculation of the effluents captured in the bottom portion of the compartment and reintroduced into the top portion at a flow rate Q≧5D_{f}.

20. The installation as claimed in claim 19, characterized in that Q≧25D_{f}.

21. The installation as claimed in claim 18, characterized in that it includes a preflotation chamber with a free surface and weak turbulence, comprising coagulation/flocculation means and effluent recirculation means in the bottom portion, said chamber being provided with scraping means in the top portion and with cavitation means for generating vertical bubbling for oxidation/separation in said chamber.

22. The installation as claimed in claim 18, characterized in that it includes electrolytic treatment means for carrying out the oxidation and/or the reduction.

23. The installation as claimed in claim 22, characterized in that the electrolytic treatment means comprise diamond-coated electrodes.

24. The installation as claimed in claim 22, characterized in that the electrolytic treatment means comprise carbon/nitrogen-coated electrodes.

25. The installation as claimed in claim 21, characterized in that the electrolytic treatment means are located in the first effluent recirculation circuit.

26. The installation as claimed in claim 18, characterized in that the second compartment comprises a second effluent recirculation circuit in the bottom portion, which includes cavitation means for generating vertical bubbling in said compartment.

27. The installation as claimed in claim 26, characterized in that the flow rate in the second recirculation circuit is low, being between D_{f}/20 and D_{f2}.

28. The installation as claimed in claim 18, characterized in that it comprises at least one second set of compartments in series with the first.

29. The installation as claimed in claim 28, characterized in that it comprises n sets of compartments in which the effluents are made to flow in series, the number n≧2 being chosen so as to obtain, little by little, a solid/liquid phase separation on the surface of the compartments having a free surface so as to bring the effluents leaving the treatment to a defined COD.

30. The installation as claimed in claim 18, characterized in that each set of compartments includes at least one intermediate third compartment between the first and second compartments, in which a post-oxidation operation is carried out with a catalyst, the effluent being agitated with moderate turbulence.

31. The installation as claimed in claim 30, characterized in that it includes, in the bottom portion of said third compartment, a third effluent circulation circuit with a flow rate D_{f}≦d≦3D_{f} in order to generate moderate turbulence in said third compartment.

32. The installation as claimed in claim 18, characterized in that the intermediate third compartment is fed in the bottom portion from the first circulation circuit which is itself provided with the electrolytic treatment means.

33. The installation as claimed in claim 18, characterized in that the bubbling is carried out with air, the mean size of the equivalent diameter of the bubbles being between 0.2 mm and 1 mm.

34. The installation as claimed in claim 18, characterized in that the compartments have a useful height of between 3 m and 5 m.
